(19) United States
(12) Patent Application Publication
(10) Pub. No.: US 2024/0177023 A1
(43) Pub. Date: May 30, 2024

(54) SYSTEM AND METHOD FOR MANAGING INFERENCE MODEL DISTRIBUTIONS IN DYNAMIC SYSTEM

(71) Applicant: Dell Products L.P., Round Rock, TX (US)

(72) Inventors: OFIR EZRIELEV, Beer Sheva (IL); JEHUDA SHEMER, Kfar Saba (IL); TOMER KUSHNIR, Omer (IL)

(21) Appl. No.: 18/060,101

(22) Filed: Nov. 30, 2022

(51) Int. Cl. G06N 5/04

(52) U.S. Cl. CPC G06N 5/04

(57) ABSTRACT

Methods and systems for managing inference models hosted by data processing systems are disclosed. To manage the inference models, the conditions to which the data processing systems are likely to be exposed are identified. The identified conditions may be used to select operating modes for inference models hosted by the data processing systems. The operating modes may define when and under which conditions the inference models hosted by the data processing systems are automatically modified. The automatic modifications may adapt the inference models to the conditions to which the data processing systems are exposed.

### FIELD

Embodiments disclosed herein relate generally to inference generation. More particularly, embodiments disclosed herein relate to systems and methods to manage inference models used to generate inferences.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements

FIG. 1 shows a block diagram illustrating a system in accordance with an embodiment.

FIG. 2A shows a block diagram illustrating an inference model manager and multiple data processing systems over time in accordance with an embodiment.

FIG. 2B shows a block diagram illustrating multiple data processing systems over time in accordance with an embodiment.

FIG. 2C shows a block diagram illustrating deployment plan generation in accordance with an embodiment.

FIG. 3A shows a flow diagram illustrating a method of obtaining inferences in accordance with an embodiment.

FIG. 3B shows a flow diagram illustrating a method of obtaining a deployment plan for inference models in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “an embodiment” or “an embodiment” means that a particular feature, structure, or characteristic described in conjunction with the embodiment can be included in at least an embodiment. The appearances of the phrases “in an embodiment” and “an embodiment” in various places in the specification do not necessarily all refer to the same embodiment.

In general, embodiments disclosed herein relate to methods and systems for managing inference models hosted by data processing systems. The inference models may generate inferences used to provide computer implemented services.

To manage the inference models, the conditions to which the data processing systems are likely to be exposed may be taken into account. The conditions to which the data processing systems are likely to be exposed may impact, for example, the accuracy of the inference models, the capacity of the data processing systems, the likelihood of data processing systems becoming impaired, etc.

To manage the inference models in view of the conditions, the data processing systems may automatically respond to the occurrence of various conditions by modifying the inference models hosted by the data processing systems. For example, the data processing systems may automatically replace inference models, deploy additional inference models, etc. By doing so, the data processing systems may be more likely to provide inferences of desired accuracy and at desirable levels of reliability while limiting the computing resources expended for inference generation.

Thus, embodiments disclosed herein may provide improved computing devices that are better able to marshal limited computing resources for inference generation while still meeting accuracy and reliability goals. Accordingly, embodiments disclosed herein may address, among others, the technical challenge of limited computing resources for providing computer implemented services. The disclosed embodiments may address this problem by improving the efficiency of use of computing resources for inference generation.

In an embodiment, a method of managing a distribution of inference models hosted by data processing systems is provided. The method may include obtaining condition data for the data processing systems, the condition data indicating how the data processing systems are likely to operate during a future period of time; obtaining a deployment plan for the inference models based on the condition data, the distribution, and inference model types available for deployment; prior to the future period of time, updating the inference models based on the deployment plan to obtain an updated distribution of the inference models; and obtaining, during the period of time, an inference using the updated distribution of the inference models.

Obtaining the condition data for the data processing systems may include at least one selected from a group consisting of: identifying a time of day associated with the future period of time; identifying an occurrence of an event; and identifying a geographic area in which at least a portion of the data processing systems are likely to reside during the future period of time.

Obtaining the deployment plan may include in an instance of the condition data that comprises the time of the day: identifying, based on the inference model types, a first inference model type associated with the time of the day; identifying a first entry of a previous deployment plan for a second inference model type that is not associated with the time of the day, the distribution of the inference models being based on the previous deployment plan; and replacing the first entry with a second entry to obtain the deployment plan, the second entry indicating that an instance of the second inference model type should be present in the distribution of the inference models.

Obtaining the deployment plan may include in an instance of the condition data that comprises the occurrence of the event: identifying, based on the inference model types, a first inference model type associated with the event; identifying a first entry of a previous deployment plan for a second inference model type that is not associated with the event, the distribution of the inference models being based on the previous deployment plan; and replacing the first entry with a second entry to obtain the deployment plan, the second entry indicating that an instance of the second inference model type should be present in the distribution of the inference models.

Obtaining the deployment plan may also include in the instance of the condition data that comprises the occurrence of the event: adding a new entry to the previous deployment plan to obtain the deployment plan, the new entry indicating that another instance of the second inference model type should be present in the distribution of the inference models.

Obtaining the deployment plan may include in an instance of the condition data that comprises the geographic location: identifying, based on the inference model types, a first inference model type associated with the geographic location; identifying a first entry of a previous deployment plan for a second inference model type that is not associated with the geographic location, the distribution of the inference models being based on the previous deployment plan; and replacing the first entry with a second entry for the first inference model type to obtain the deployment plan.

The distribution of the inference models may include an inference model over fitted for a second time of the day, the updated distribution of the inference model comprises a second inference model overfitted for the time of the day, and the inference model is not a member of the updated distribution of the inference models.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

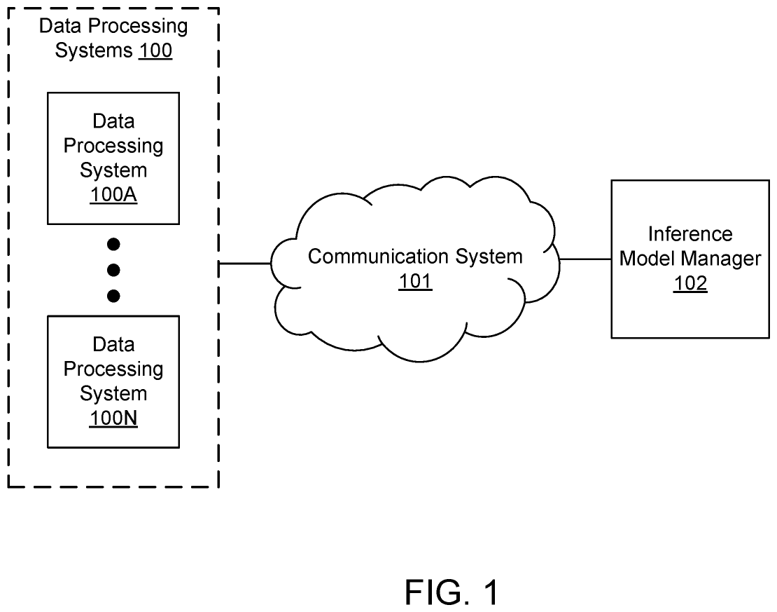

Turning to FIG. 1, a block diagram illustrating a system in accordance with an embodiment is shown. The system shown in FIG. 1 may provide computer-implemented services that may utilize inferences generated by executing inference models hosted by data processing systems throughout a distributed environment.

The system may include inference model manager 102. Inference model manager 102 may provide all, or a portion, of the computer-implemented services. For example, inference model manager 102 may provide computer-implemented services to users of inference model manager 102 and/or other computing devices operably connected to inference model manager 102. The computer-implemented services may include any type and quantity of services which may utilize, at least in part, inferences generated by the inference models hosted by the data processing systems throughout the distributed environment.

To facilitate execution of the inference models, the system may include one or more data processing systems 100. Data processing systems 100 may include any number of data processing systems (e.g., 100A-100N). For example, data processing systems 100 may include one data processing system (e.g., 100A) or multiple data processing systems (e.g., 100A-100N) that may independently and/or cooperatively facilitate the execution of the inference models.

For example, all, or a portion, of data processing systems 100 may provide computer-implemented services to users and/or other computing devices operably connected to data processing systems 100. The computer-implemented services may include any type and quantity of services including, for example, generation of a partial or complete processing result using an inference model of the inference models. Different data processing systems may provide similar and/or different computer-implemented services.

The quality of the computer-implemented services (e.g., provided by data processing systems 100 and/or other device that are not shown in FIG. 1 that may utilize inference to provide computer implemented services) depend on the accuracy of the inferences and/or availability of inferences. For example, if an inference is inaccurate or unavailable when needed, the computer implemented services may not meet the goals of downstream consumers of the computer implemented services.

In general, embodiments disclosed herein may provide methods, systems, and/or devices for managing execution of inference models hosted by data processing systems 100. To manage execution of the inference models hosted by data processing systems 100, a system in accordance with an embodiment may monitor conditions (e.g., also referred to as “operating conditions”) impacting data processing systems 100. The conditions may include, for example, a type of environment in which any of data processing systems 100 reside, occurrences of events impacting any of data processing systems 100, geographic locations in which any of data processing systems 100 are positioned, and/or other types of conditions that may impact any of data processing systems 100.

Using the monitored conditions, a deployment plan inference models hosted by data processing systems 100 may be revised (e.g., continuously, in accordance with a schedule, in response to occurrences of certain events, etc.). The deployment plan may indicate distributions of inference models across data processing systems 100 during a period of time and/or modes of operation of the inference models. For example, the deployment plan may indicate (i) numbers and types of inference models to be hosted by the data processing systems, (ii) division of each of the inference models into various portions, (iii) identities of data processing systems 100 to host the portions of the inference models, and/or other information usable to ascertain, and/or (iv) other information usable to coordinate and/or manage execution of the inference models. Similarly, the deployment plan may indicate whether the data processing systems are to operate in (i) a circular operating model where the distribution of inference models is periodically changed over time, (ii) an event responsive operating mode where occurrences of events automatically trigger change in the distribution of inference models, and/or (iii) location responsive operating mode where changes in geographic location change the distribution of the inference models. Once distributed (entirely or in part) to data processing systems 100, data processing systems 100 may implement the deployment plan.

By doing so, embodiments disclosed herein may provide a system that is better able to dynamically respond to changes conditions impacting data processing systems hosting inference models. For example, edge computing devices, user devices, internet of things (IOT) devices, and/or other types of computing devices may be exposed to a variety of conditions that may impact, for example, their connectivity (e.g., ability to communicate with other devices), thermal management capabilities (e.g., ability to cool itself or warm itself), power management capabilities (e.g., ability to obtain power), and/or capabilities. By automatically responding to conditions that may impact these capabilities, a system in accordance with embodiments disclosed herein may be more likely to provide more accurate inferences more reliably. Thus, embodiments disclosed herein may provide an improved computing system that is more likely to be able to continue to provide desired computer implemented services while condition to which the data processing systems that provide (at least in part) the computer implemented services are exposed change over time.

To provide the above noted functionality, the system of FIG. 1 may include inference model manager 102. Inference model manager 102 may (i) monitor conditions impacting data processing systems 100, (ii) generate deployment plans, (iii) distribute the deployment plans so that data processing systems 100 host portions of inference models necessary to generate inferences, and/or (iv) use the inferences to satisfy the needs of downstream consumers of inferences. By doing so, inference model manager 102 may manage inference models in a manner that is more likely to result in generation of higher accuracy inferences.

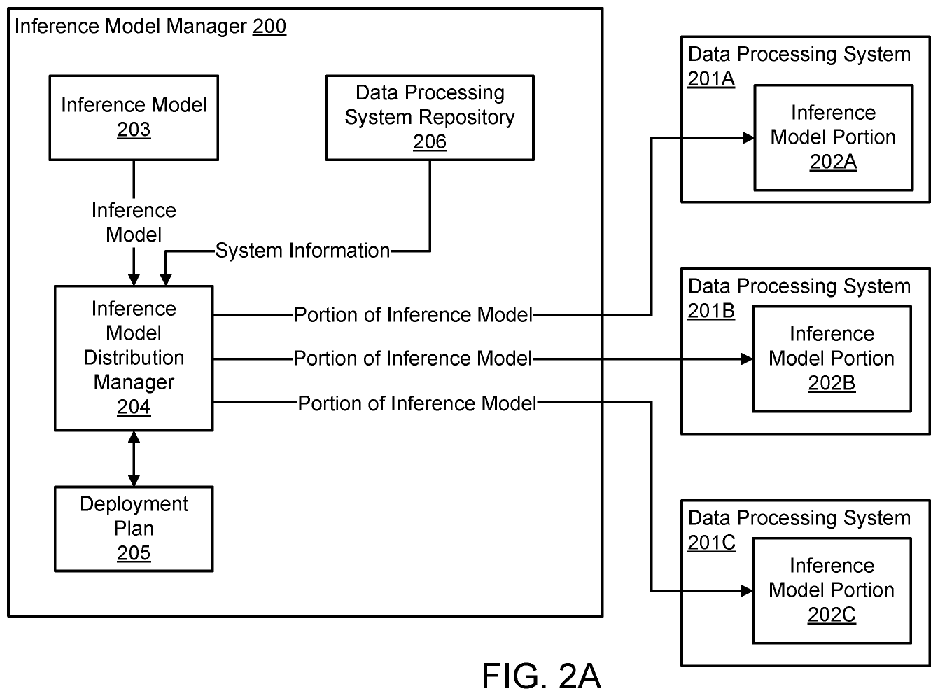

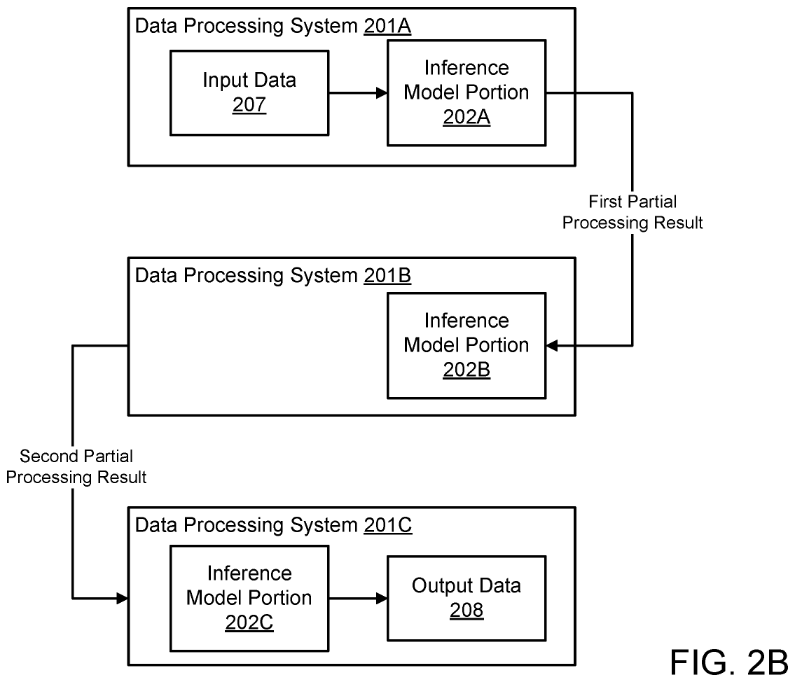

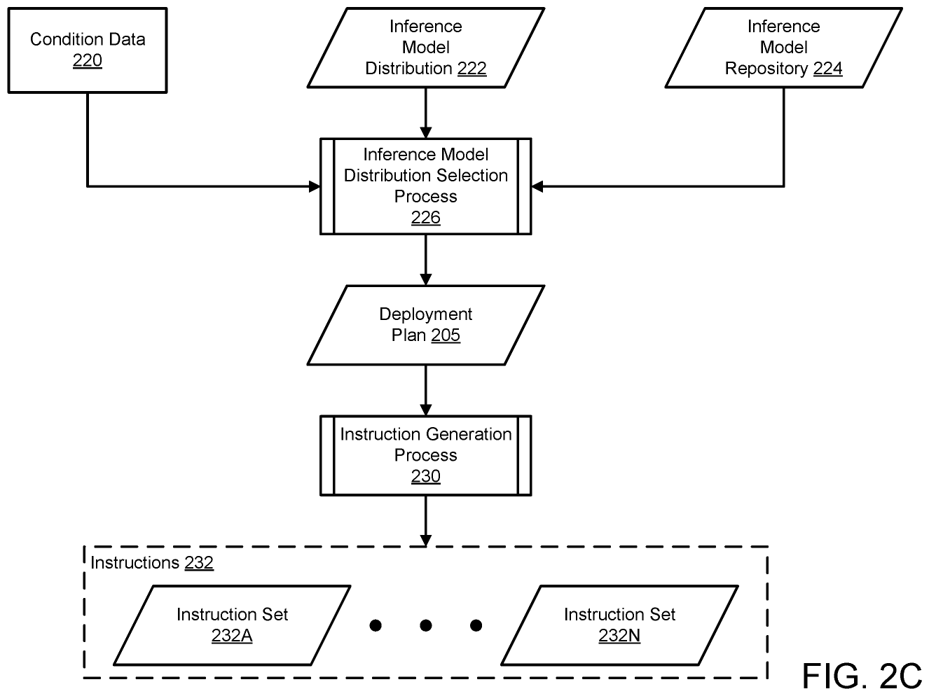

Any of the inference models hosted by data processing systems 100 may be distributed. For example, any of the inference models may be implemented using trained neural networks. The trained neural network may include, for example, an input layer, any number of hidden layers, an output layer, and/or other layers. The trained neural networks may be divided into any number of portions and distributed across data processing systems 100. For example, the inference models may be distributed in this manner due to the limited computing resources available to each of data processing systems 100. The inference models may be divided using any method. The deployment plan may take into account this division and may provide for distributed execution of the inference models (e.g., may include information indicating where partial results are to be forwarded). Refer to FIGS. 2A-2B regarding generation of inferences. Refer to FIG. 2C for additional details regarding generation and use of deployment plans.

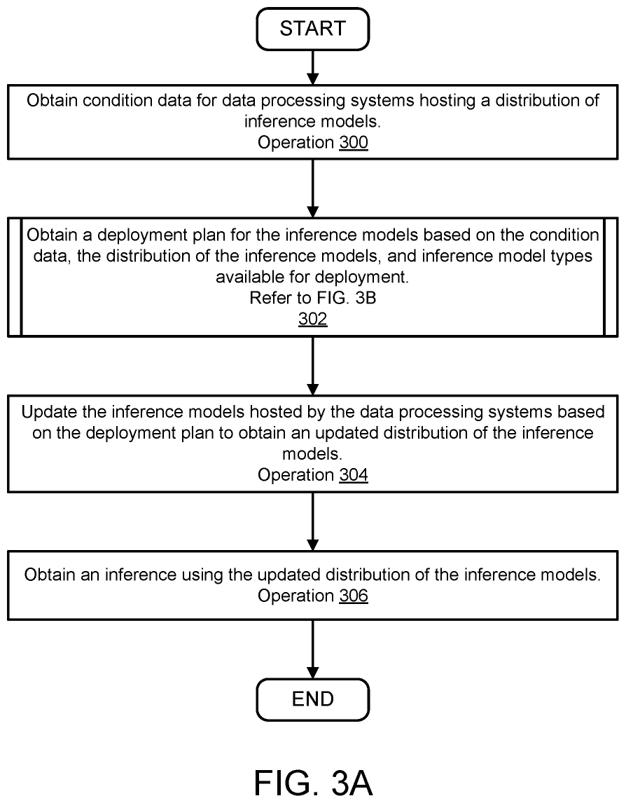

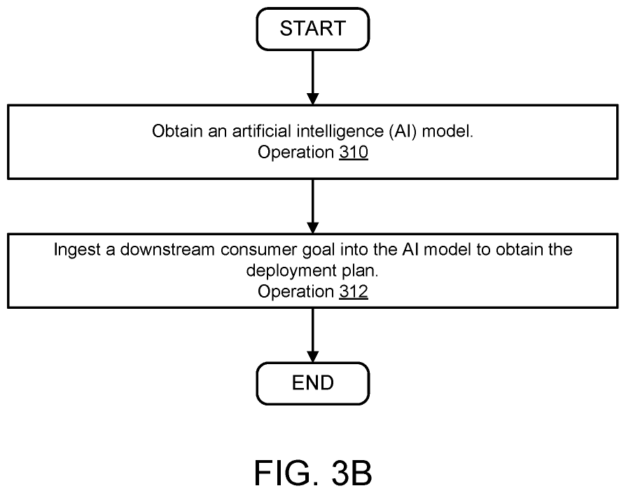

When performing its functionality, inference model manager 102 and/or data processing systems 100 may perform all, or a portion, of the methods and/or actions shown in FIGS. 3A-3B.

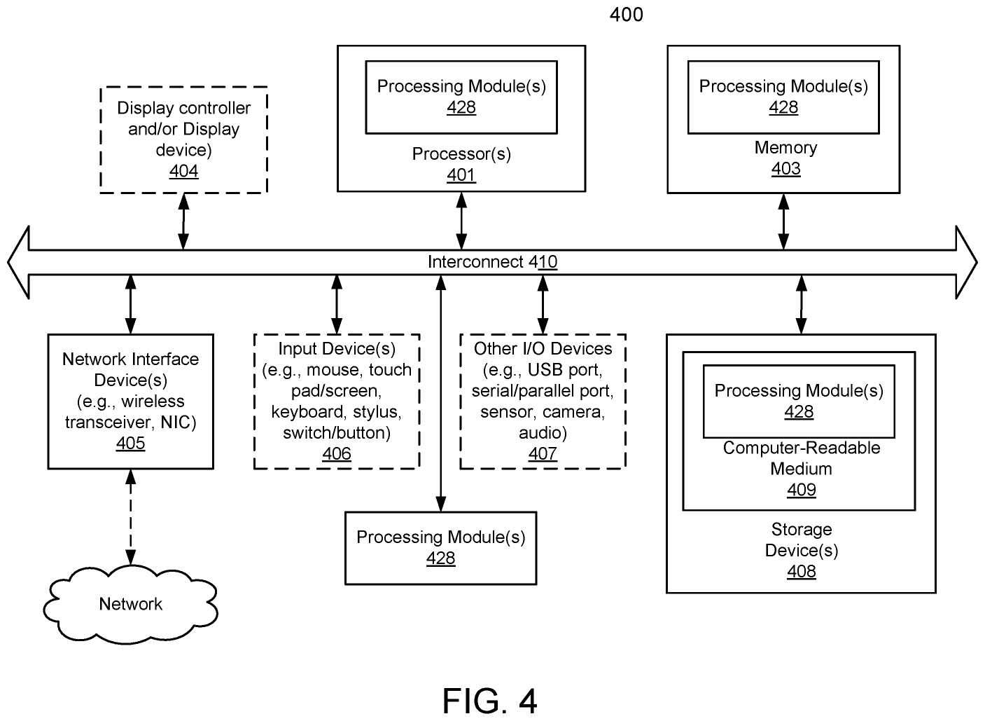

Data processing systems 100 and/or inference model manager 102 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

In an embodiment, one or more of data processing systems 100 and/or inference model manager 102 are implemented using an IoT device, which may include a computing device. The IoT device may operate in accordance with a communication model and/or management model known to inference model manager 102, other data processing systems, and/or other devices.

Any of the components illustrated in FIG. 1 may be operably connected to each other (and/or components not illustrated) with communication system 101. In an embodiment, communication system 101 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, diagrams illustrating data flows and/or processes performed in a system in accordance with an embodiment are shown in FIGS. 2A-2C. Specifically, FIGS. 2A-2B illustrate data flows during deployment and execution of distributed inference models, and FIG. 2C illustrates data flow during generation and use of deployment plans.

Turning to FIG. 2A, a diagram of inference model manager 200 and data processing systems 201A-201C in accordance with an embodiment is shown. Inference model manager 200 may be similar to inference model manager 102, and data processing systems 201A-201C may be similar to any of data processing systems 100. In FIG. 2A, inference model manager 200 and data processing systems 201A-201C are connected to each other via a communication system (not shown). Communications between inference model manager 200 and data processing systems 201A-201C are illustrated using lines terminating in arrows.

As discussed above, inference model manager 200 may perform computer-implemented services by executing an inference model across multiple data processing systems that each individually have insufficient computing resources (e.g., storage space, processing bandwidth, memory space, etc.) to complete timely execution (e.g., in accordance with an expectation of an entity, such as a downstream consumer of an inference) of the inference model.

While described below with reference to a single inference model (e.g., inference model 203), the process may be repeated any number of times with any number of inference models without departing from embodiments disclosed herein. For example, as part of generating and implementing a deployment plan.

To execute an inference model across multiple data processing systems, inference model manager 200 may obtain inference model portions and may distribute the inference model portions to data processing systems 201A-201C. The inference model portions may be based on: (i) the computing resource availability of data processing systems 201A-201C and (ii) communication bandwidth availability between the data processing systems. By doing so, inference model manager 200 may distribute the computational overhead and bandwidth consumption associated with hosting and operating the inference model across multiple data processing systems. While described and illustrated with respect to distributing inference model portions, it will be appreciated that instructions for which inference models portions to host may be distributed to the data processing systems (or other entities) and the data processing systems may take responsibility for obtaining and hosting the inference models portions without departing from embodiments disclosed herein.

To obtain inference model portions, inference model manager 200 may host inference model distribution manager 204. Inference model distribution manager 204 may (i) obtain an inference model and/or deployment plan 205, (ii) identify characteristics (e.g., available computing resources/communication bandwidth) of data processing systems to which the inference model may be deployed, (iii) obtain inference model portions based on the characteristics of the data processing systems and characteristics of the inference model, (iv) distribute the inference model portions to the data processing systems, (v) initiate execution of the inference model using the inference model portions distributed to the data processing systems and/or (vi) manage the execution of the inference model based on deployment plan 205.

Inference model manager 200 may obtain inference model 203. Inference model manager 200 may obtain characteristics of inference model 203. The characteristics of inference model 203 may include, for example, a quantity of layers of a neural network inference model and a quantity of relationships between the layers of the neural network inference model. The characteristics of inference model 203 may also include the quantity of computing resources required to host and operate inference model 203. The characteristics of inference model 203 may include other characteristics based on other types of inference models without departing from embodiments disclosed herein.

Each portion of inference model 203 may be distributed to one data processing system throughout a distributed environment. Therefore, prior to determining the portions of inference model 203, inference model distribution manager 204 may obtain system information from data processing system repository 206. System information may include a quantity of the data processing systems, a quantity of available memory of each data processing system of the data processing systems, a quantity of available storage of each data processing system of the data processing systems, a quantity of available communication bandwidth between each data processing system of the data processing systems and other data processing systems of the data processing systems, and/or a quantity of available processing resources of each data processing system of the data processing systems.

Therefore, inference model distribution manager 204 may obtain a first portion of the inference model (e.g., inference model portion 202A) based on the system information (e.g., the available computing resources) associated with data processing system 201A and based on data dependencies of the inference model so that inference model portion 202A reduces the necessary communications between inference model portion 202A and other portions of the inference model. Inference model distribution manager 204 may repeat the previously described process for inference model portion 202B and inference model portion 202C.

Prior to distributing inference model portions 202A-202C, inference model distribution manager 204 may obtain deployment plan 205. Deployment plan 205 may indicate the distribution of the inference model portions across data processing systems and/or modes of operation for the distributed inference models. Refer to FIG. 2C for additional details regarding deployment plan 205.

Inference model manager 200 may distribute inference model portion 202A to data processing system 201A, inference model portion 202B to data processing system 201B, and inference model portion 202C to data processing system 201C. While shown in FIG. 2A as distributing three portions of the inference model to three data processing systems, the inference model may be partitioned into any number of portions and distributed to any number of data processing systems throughout a distributed environment.

Further, while not shown in FIG. 2A, inference model distribution manager 204 may, in accordance with deployment plan 205, distribute (i) redundant copies of the inference model portions to various data processing systems, (ii) distribution copies of other inference model portions to comply with various modes of operation specified by deployment plan 205, and/or (iii) may otherwise prepare data processing systems to respond to changing conditions.

Once deployed, inference model portions (e.g., 202A-202C) may execute thereby generating inferences.

In an embodiment, inference model distribution manager 204 is implemented using a processor adapted to execute computing code stored on a persistent storage that when executed by the processor performs the functionality of inference model distribution manager 204 discussed throughout this application. The processor may be a hardware processor including circuitry such as, for example, a central processing unit, a processing core, or a microcontroller. The processor may be other types of hardware devices for processing information without departing from embodiments disclosed herein.

Turning to FIG. 2B, diagram illustrating data flow during execution of inference models portions (e.g., 202A-202C) in accordance with an embodiment is shown. While executing, data processing system 201A may obtain input data 207. Input data 207 may include any data of interest (or that may otherwise used as a basis for an inference) to a downstream consumer of the inferences. For example, input data 207 may include data indicating the operability and/or specifications of a product on an assembly line.

Input data 207 may be fed into inference model portion 202A to obtain a first partial processing result. The first partial processing result may include values and/or parameters associated with a portion of the inference model. The first partial processing result may be transmitted (e.g., via a wireless communication system) to data processing system 201B. Data processing system 201B may feed the first partial processing result into inference model portion 202B to obtain a second partial processing result. The second partial processing result may include values and/or parameters associated with a second portion of the inference model. The second partial processing result may be transmitted to data processing system 201C. Data processing system 201C may feed the second partial processing result into inference model portion 202C to obtain output data 208. Output data 208 may include inferences collectively generated by the portions of the inference model distributed across data processing systems 201A-201C.

Output data 208 may be utilized by a downstream consumer of the data to perform a task, make a decision, and/or perform any other action set that may rely on the inferences generated by the inference model. For example, output data 208 may include a quality control determination regarding a product manufactured in an industrial environment. Output data 208 may indicate whether the product meets the quality control standards and should be retained or does not meet the quality control standards and should be discarded. In this example, output data 208 may be used by a robotic arm to decide whether to place the product in a “retain” area or a “discard” area.

While shown in FIG. 2B as including three data processing systems, a system may include any number of data processing systems to collectively execute the inference model. Additionally, as noted above, redundant copies of the inference model hosted by multiple data processing systems may each be maintained so that termination of any portion of the inference model may not impair the continued operation of the inference model. Similarly, while not shown, dormant copies of other inference models may also be at least stored in data processing systems 201A-201C and/or other data processing systems not shown so that the data processing systems may be able to respond to various conditions in accordance with a deployment plan. In addition, while described in FIG. 2B as including one inference model, the system may include multiple inference models distributed across multiple data processing systems.

While described above as feeding input data 207 into data processing system 201A and obtaining output data 208 via data processing system 201C, other data processing systems may utilize input data and/or obtain output data without departing from embodiments disclosed herein. For example, data processing system 201B and/or data processing system 201C may obtain input data (not shown). In another example, data processing system 201A and/or data processing system 201B may generate output data (not shown). A downstream consumer may be configured to utilize output data obtained from data processing system 201A and/or data processing system 201B to perform a task, make a decision, and/or perform an action set.

By executing an inference model across multiple data processing systems, computing resource expenditure throughout the distributed environment may be reduced. In addition, by managing execution of the inference model, the functionality and/or connectivity of the data processing systems may be adapted over time to remain in compliance with the needs of a downstream consumer.

Turning to FIG. 2C, a data flow diagram illustrating generation and use of a deployment plan in accordance with an embodiment is shown.

To obtain deployment plan 205, inference model distribution selection process 226 may be performed. Inference model distribution selection process 226 may include ingesting various information into an inference model trained to output deployment plan 205, reviewed in accordance with a set of expert rules to obtain deployment plan 205, and/or otherwise used to obtain deployment plan 205. For example, if implemented with an inference model, the inference model make ingest condition data 220, inference model distribution 222 (e.g., an existing distribution), and information regarding inference model repository 224 (e.g., a repository of inference models that may be deployed).

Condition data 220 may include any type and quantity of information regarding the conditions encountered by data processing systems to which inference models may be deployed. Condition data 220 may include, for example, information regarding the computing resources of the data processing systems, environments surrounding the data processing systems (e.g., temperatures, weather patterns, etc.), events that have historically impacted the data processing systems (e.g., impairment/loss of data processing systems), geographic locations of the data processing systems, etc. The information included in condition data 220 may be self-reported by the data processing systems and/or obtained from other sources (e.g., weather reporting systems, geographic location reporting systems, etc.0.

Inference model distribution 222 may include any type and quantity of information regarding an existing distribution of inference models hosted by data processing systems. For example, inference model distribution 222 may indicate the numbers, types, and hosting locations of various portions of inference models (active or inactive) hosted by data processing systems.

Inference model repository 224 may include any number and type of inference models, and information regarding the inference models. For example, inference model repository 224 may indicate (i) the type of input and type of output of each inference model, (ii) complexity levels of the inference models and/or relationships between higher and lower complexity versions of models (e.g., high complexity may be more likely to provide accurate output when compared to lower complexity models), (iii) quantities of computing resources necessary to execute the inference models, and/or (iv) other information regarding the inference models.

Condition data 220, inference model distribution 222, inference model repository 224, and/or other information such as goals of downstream consumers of the inferences may be used to obtain deployment plan 205 which may indicate (i) a new distribution of inference models and (ii) an operating mode for the inference models. The new distribution of the inference models may indicate numbers and types of inference models to be deployed. The operating mode may specify how the inference models are to be operated over time.

The operating mode may be obtained, for example, based on past historical data regarding events impacting data processing systems, sensitivities of models to be deployed to the data processing systems, goals of downstream consumers, and/or other factors. For example, the operating models may be associated (e.g., based on heuristically obtained information) with various distribution of inference models. The associations may be stored in a lookup table or other data structure thereby allowing for operating modes for each type of distribution of inference model to be identified. The operating mode may define how the data processing system hosting an inference model is to manage the inference model automatically over time.

Once obtained, deployment plan 205 may be used to obtain instructions 232 via instruction generation process 230. For example, deployment plan 205 may be parsed with respect to each data processing system, and a customized instruction set (e.g., 232A, 232N) may be prepared. Once obtained, the instruction sets may be provided to the data processing systems. The instructions may include information regarding the inference model portion(s) to be hosted by the data processing system, and information regarding how to respond to the occurrence of various operating conditions. For example, the instruction sets may specify operating modes with respect to the inference models.

In an example in which the operating mode is a circular operating mode, an instruction set may specify a schedule when various inference models hosted by the data processing system are to be active and dormant. The schedule may, for example, correspond to various times when each of the inference models are most likely to be useful and/or provide higher accuracy inferences.

In another example in which the operating model is event responsive, an instruction set may specify when various inference models hosted by the data processing system are to be active and dormant responsive to various events. The events may be identified by the host data processing system or other devices, and may trigger activation of various inference models and/or deactivation (e.g., to place them in dormant states) of various inference models.

In an additional example in which the operating model is location responsive, an instruction set may specify when various inference models hosted by the data processing system are to be active and dormant responsive to changes in geographic location of the data processing system. The geographic location may be identified by the host data processing system or other devices, and may trigger activation of various inference models and/or deactivation (e.g., to place them in dormant states) of various inference models.

Thus, via any of the above operating modes, the distribution of inference models hosted by data processing systems may automatically change in accordance with deployment plan 205. While described with respect to these example operating modes, it will be appreciated that deployment plan 205 may indicate that any data processing system is subject to one or more operating modes without departing from embodiments disclosed herein. For example, a data processing system may be tasked with both conforming its operation to a circular operating mode as well as an event responsive operating mode.

As discussed above, the components of FIG. 1 may perform various methods to execute inference models throughout a distributed environment. FIGS. 3A-3B illustrates methods that may be performed by the components of FIG. 1. In the diagrams discussed below and shown in FIGS. 3A-3B, any of the operations may be repeated, performed in different orders, and/or performed in parallel with or in a partially overlapping in time manner with other operations.

Turning to FIG. 3A, a flow diagram illustrating a method of managing inference models hosted by data processing systems in accordance with an embodiment is shown. The method may be performed, for example, by data processing systems (e.g., 100), an inference model manager (e.g., 102), and/or other components.

At operation 300, condition data for data processing systems hosting a distribution of inference models is obtained. The condition data may be obtained by (i) receiving it from the data processing systems, (ii) receiving it from other entities, (iii) reading it from storage, and/or (iv) via other methods. The condition data may, as noted above, indicate conditions to which the data processing systems are exposed, conditions of the data processing systems (e.g., available computing resources), and/or other information usable to ascertain the capabilities of the data processing systems to host inference models in the future and/or successfully complete execution of inference models in the future.

At operation 302, a deployment plan for the inference models is obtained based on the condition data, the distribution of the in inference models, and/or inference model types available for deployment (e.g., also referred to as “decision data”). The deployment plan may be obtained by (i) ingesting the decision data into an inference model trained to predict an optimal deployment plan for a future period of time, (ii) using an expert set of rules to select the deployment plan based on the decision data, and/or via other methods. In an embodiment, the deployment plan is obtained via the method illustrated in FIG. 3B.

The deployment plan may specify (i) a new distribution of the inference models and (ii) any number (e.g., 0, 1 2, 3, etc.) and types of operating modes for the data processing systems. The operating models may specify, for example, schedules, events, and/or other criteria for automatically changing the inference models hosted by the data processing systems.

The new distribution may indicate how each of the inference models in the new distribution are to be portioned (e.g., divided into portions), where the portions of the inference models are to be hosted (e.g., which data processing system), whether each portion is to be active, and/or other information usable to establish and manage the new inference model distribution.

At operation 304, the inference models hosted by the data processing systems are updated based on the deployment plan to obtain an updated distribution of the inference models. The inference models may be updated by (i) deploying inference models to the data processing systems and/or terminating existing inference models to conform the inference models to the new distribution, (ii) providing instructions to the data processing systems and waiting for the data processing to instantiate/terminate inference models to confirm to the new distribution, and/or (iii) provide information regarding the operating mode(s) to be implemented by the data processing systems.

By providing the information regarding the operating mode(s) to be implemented by the data processing systems, the data processing systems may automatically update the distribution of the inference models over time.

For example, consider a scenario where a downstream consumer desires very high accurate inferences which are made using temperature data. However, due to fluctuations in temperature due to the day-night cycle, a generalized inference model capable of providing sufficiently high accuracy inferences over the complete day-night cycle may not be available, may be prohibitively computationally expensive to execute, or may otherwise be unable to be implemented. However, various inference models capable of meeting the accuracy requirement within computational capabilities of data processing systems may be available. In this scenario, copies of multiple inference models may be deployed with a circular operating mode that defines when each of the inference models is to be active. The circular operating mode may automatically cause each of the inference models to operating during time of the day when they a each likely to provide accurate inferences, and to be dormant during other periods of time.

In another example, consider a scenario where a downstream consumer is managing a processes that is highly sensitive to a certain range of inferences generated by an inference model. To manage risk associated with the high degree of sensitivity, biased inference models may be deployed that tend to generate inferences biased toward the range of high sensitivity (e.g., to conservatively indicate when the parameter may be entering the range), and an event responsive operating mode may also be set such that additional inference models are automatically deployed when the biased inference models generate inferences in the range of high sensitivity and the additional inference models are to be terminated when the inferences are out of the range of high sensitivity. The additional inference models may, for example, be of high accuracy while the biased inference models may be of low accuracy. In this scenario, the inference from the higher accuracy inference models may be automatically (e.g., when available) used by the downstream consumer to manage the processes.

At operation 306, an inference is obtained using the updated distribution of the inference models. The inference may be obtained via execution of the updated distribution of the inference models. The inference may be obtained prior to and/or after modification of the updated distribution of the inference models due to operating modes implemented by the data processing systems.

For example, after the updated distribution of the inference models is initially obtained based on the deployment plan, the distribution may be further changed due to operating modes implemented by the data processing systems which may automatically change the inference models hosted by the data processing systems. The change in the updated distribution may improve the accuracy and/or reliability of inferences as the conditions faced by the data processing systems changes over time.

The method may end following operation 306.

Turning to FIG. 3B, a flow diagram illustrating a method of obtaining a deployment plan in accordance with an embodiment is shown. The method may be performed, for example, by data processing systems (e.g., 100), an inference model manager (e.g., 102), and/or other components.

At operation 310, an Artificial Intelligence (AI) model is obtained. The AI model may be obtained by (i) obtaining training data and (ii) training an AI model using the training data.

The training data may include (i) various distributions of inference models and (ii) rankings regarding how well inferences obtained with the inference models distributions met downstream consumer goals. The training data may be obtained by establishing multiple distributions of inference models based on a downstream consumer goal, obtaining inferences using the distributions of inference models, and ranking distributions of the inference models based on how well the inferences met the downstream consumer's goal.

The AI model may be trained using any training modality. For example, in the context of neural network inference model, the AI model may be trained by using an objective function to select the weights of the hidden layers (and/or other variable parameters of the neural network). The objective function may optimize the weights so that the trained AI model outputs a distribution of inference models that is best ranked for a given downstream consumer goal.

At operation 312, a downstream consumer goal is ingested into the AI model to obtain the deployment plan as output from the AI model. The downstream consumer goal may be ingested by providing the downstream consumer goal (e.g., a representation of it) to an input layer of the trained AI model. The trained AI model may output the inference model distribution as output.

To take into other consideration, an optimization function may be used. The optimization function may be used to modify the distribution obtained from the trained AI model. For example, the optimization function may rank the distribution based on the existing distribution of inference models, and available inference models. Changes to the distribution may also be ranked. An objective function may be used to perform the ranking. The objective function may penalize inference model distributions that replace existing inference models, and/or use certain types of inference models (e.g., high complexity). The objective function may also take into account how well the predicted operation of each modification of the inference model distribution meets the downstream consumer goal. Thus, the distribution may be based on the goal of the downstream consumer, the condition data, the existing distribution of inference models, and inference model types available for deployment.

The deployment plan may then be obtained by identify one or more operating modes. The operating mode may be identified based on condition data for the data processing systems, the downstream consumer goal, and/or other factors. For example, the condition data may be analyzed to identify patterns in the conditions to which the data processing systems are exposed (e.g., which may indicate circular, event, or geographically driven modes of operation). Similarly, the intent of the downstream consumer may be inferred based on the downstream consumer goal. (e.g., which may indicate an event driven mode of operation when biased inference models are to be deployed). The distribution of the inference models may also be analyzed to ascertain whether there may be benefit to some of the operating modes.

The resulting deployment plan may include both the distribution of the inference models and the operating modes. In the event that the inference models are to be portioned and distributed, the deployment plan may be further revised by dividing the inference models into portions and selecting data processing systems to host the respective portions of the inference models.

The method may end following operation 312.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In an embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in an embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of managing a distribution of inference models hosted by data processing systems, the method comprising:
obtaining condition data for the data processing systems, the condition data indicating how the data processing systems are likely to operate during a future period of time;
obtaining a deployment plan for the inference models based on the condition data, the distribution, and inference model types available for deployment, the deployment plan specify an operating mode and a new distribution for the data processing system;
prior to the future period of time, updating the inference models based on the deployment plan to obtain an updated distribution of the inference models; and
obtaining, during the period of time, an inference using the updated distribution of the inference models and the operating mode, the operating mode indicating at least one automatically implemented change to the updated distribution of the inference models responsive to an occurrence of a condition.

2. The method of claim 1, wherein obtaining the condition data for the data processing systems comprises at least one selected from a group consisting of:
identifying a time of day associated with the future period of time;
identifying an occurrence of an event; and
identifying a geographic area in which at least a portion of the data processing systems are likely to reside during the future period of time.

3. The method of claim 2, wherein obtaining the deployment plan comprises:
in an instance of the condition data that comprises the time of the day:
identifying, based on the inference model types, a first inference model type associated with the time of the day;
identifying a first entry of a previous deployment plan for a second inference model type that is not associated with the time of the day, the distribution of the inference models being based on the previous deployment plan; and
replacing the first entry with a second entry to obtain the deployment plan, the second entry indicating that an instance of the second inference model type should be present in the distribution of the inference models.

4. The method of claim 2, wherein obtaining the deployment plan comprises:
in an instance of the condition data that comprises the occurrence of the event:
identifying, based on the inference model types, a first inference model type associated with the event;
identifying a first entry of a previous deployment plan for a second inference model type that is not associated with the event, the distribution of the inference models being based on the previous deployment plan; and
replacing the first entry with a second entry to obtain the deployment plan, the second entry indicating that an instance of the second inference model type should be present in the distribution of the inference models.

5. The method of claim 4, wherein obtaining the deployment plan further comprises:
in the instance of the condition data that comprises the occurrence of the event:
adding a new entry to the previous deployment plan to obtain the deployment plan, the new entry indicating that another instance of the second inference model type should be present in the distribution of the inference models.

6. The method of claim 2, wherein obtaining the deployment plan comprises:
in an instance of the condition data that comprises the geographic location:
identifying, based on the inference model types, a first inference model type associated with the geographic location;
identifying a first entry of a previous deployment plan for a second inference model type that is not associated with the geographic location, the distribution of the inference models being based on the previous deployment plan; and
replacing the first entry with a second entry for the first inference model type to obtain the deployment plan.

7. The method of claim 2, wherein the distribution of the inference models comprises an inference model over fitted for a second time of the day, the updated distribution of the inference model comprises a second inference model overfitted for the time of the days, and the inference model is not a member of the updated distribution of the inference models.

8. A non-transitory machine-readable medium having instructions stored therein, which when executed by a processor, cause the processor to perform operations for managing a distribution of inference models hosted by data processing systems, the operations comprising:
obtaining condition data for the data processing systems, the condition data indicating how the data processing systems are likely to operate during a future period of time;
obtaining a deployment plan for the inference models based on the condition data, the distribution, and inference model types available for deployment, the deployment plan specify an operating mode and a new distribution for the data processing system;
prior to the future period of time, updating the inference models based on the deployment plan to obtain an updated distribution of the inference models; and
obtaining, during the period of time, an inference using the updated distribution of the inference models and the operating mode, the operating mode indicating at least one automatically implemented change to the updated distribution of the inference models responsive to an occurrence of a condition.

9. The non-transitory machine-readable medium of claim 8, wherein obtaining the condition data for the data processing systems comprises at least one selected from a group consisting of:
identifying a time of day associated with the future period of time;
identifying an occurrence of an event; and
identifying a geographic area in which at least a portion of the data processing systems are likely to reside during the future period of time.

10. The non-transitory machine-readable medium of claim 9, wherein obtaining the deployment plan comprises:
in an instance of the condition data that comprises the time of the day:
identifying, based on the inference model types, a first inference model type associated with the time of the day;
identifying a first entry of a previous deployment plan for a second inference model type that is not associated with the time of the day, the distribution of the inference models being based on the previous deployment plan; and
replacing the first entry with a second entry to obtain the deployment plan, the second entry indicating that an instance of the second inference model type should be present in the distribution of the inference models.

11. The non-transitory machine-readable medium of claim 9, wherein obtaining the deployment plan comprises:
in an instance of the condition data that comprises the occurrence of the event:
identifying, based on the inference model types, a first inference model type associated with the event;
identifying a first entry of a previous deployment plan for a second inference model type that is not associated with the event, the distribution of the inference models being based on the previous deployment plan; and
replacing the first entry with a second entry to obtain the deployment plan, the second entry indicating that an instance of the second inference model type should be present in the distribution of the inference models.

12. The non-transitory machine-readable medium of claim 11, wherein obtaining the deployment plan further comprises:
in the instance of the condition data that comprises the occurrence of the event:
adding a new entry to the previous deployment plan to obtain the deployment plan, the new entry indicating that another instance of the second inference model type should be present in the distribution of the inference models.

13. The non-transitory machine-readable medium of claim 9, wherein obtaining the deployment plan comprises:
in an instance of the condition data that comprises the geographic location:
identifying, based on the inference model types, a first inference model type associated with the geographic location;
identifying a first entry of a previous deployment plan for a second inference model type that is not associated with the geographic location, the distribution of the inference models being based on the previous deployment plan; and
replacing the first entry with a second entry for the first inference model type to obtain the deployment plan.

14. The non-transitory machine-readable medium of claim 9, wherein the distribution of the inference models comprises an inference model over fitted for a second time of the day, the updated distribution of the inference model comprises a second inference model overfitted for the time of the days, and the inference model is not a member of the updated distribution of the inference models.

15. A data processing system, comprising:
a processor; and
a memory coupled to the processor to store instructions, which when executed by the processor, cause the processor to perform operations for managing a distribution of inference models hosted by data processing systems, the operations comprising:
obtaining condition data for the data processing systems, the condition data indicating how the data processing systems are likely to operate during a future period of time;
obtaining a deployment plan for the inference models based on the condition data, the distribution, and inference model types available for deployment, the deployment plan specify an operating mode and a new distribution for the data processing system;
prior to the future period of time, updating the inference models based on the deployment plan to obtain an updated distribution of the inference models; and
obtaining, during the period of time, an inference using the updated distribution of the inference models and the operating mode, the operating mode indicating at least one automatically implemented change to the updated distribution of the inference models responsive to an occurrence of a condition.

16. The data processing system of claim 15, wherein obtaining the condition data for the data processing systems comprises at least one selected from a group consisting of:
identifying a time of day associated with the future period of time;
identifying an occurrence of an event; and
identifying a geographic area in which at least a portion of the data processing systems are likely to reside during the future period of time.

17. The data processing system of claim 16, wherein obtaining the deployment plan comprises:
in an instance of the condition data that comprises the time of the day:
identifying, based on the inference model types, a first inference model type associated with the time of the day;
identifying a first entry of a previous deployment plan for a second inference model type that is not associated with the time of the day, the distribution of the inference models being based on the previous deployment plan; and
replacing the first entry with a second entry to obtain the deployment plan, the second entry indicating that an instance of the second inference model type should be present in the distribution of the inference models.

18. The data processing system of claim 16, wherein obtaining the deployment plan comprises:
in an instance of the condition data that comprises the occurrence of the event:
identifying, based on the inference model types, a first inference model type associated with the event;
identifying a first entry of a previous deployment plan for a second inference model type that is not associated with the event, the distribution of the inference models being based on the previous deployment plan; and
replacing the first entry with a second entry to obtain the deployment plan, the second entry indicating that an instance of the second inference model type should be present in the distribution of the inference models.

19. The data processing system of claim 18, wherein obtaining the deployment plan further comprises:
in the instance of the condition data that comprises the occurrence of the event:
adding a new entry to the previous deployment plan to obtain the deployment plan, the new entry indicating that another instance of the second inference model type should be present in the distribution of the inference models.

20. The data processing system of claim 16, wherein obtaining the deployment plan comprises:
in an instance of the condition data that comprises the geographic location:
identifying, based on the inference model types, a first inference model type associated with the geographic location;
identifying a first entry of a previous deployment plan for a second inference model type that is not associated with the geographic location, the distribution of the inference models being based on the previous deployment plan; and
replacing the first entry with a second entry for the first inference model type to obtain the deployment plan.
